(19) United States
(12) Patent Application Publication
(10) Pub. No.: US 2009/0254306 A1
(43) Pub. Date: Oct. 8, 2009

(54) APPARATUS AND METHOD FOR MEASURING RECORDING MEDIUM THICKNESS, APPARATUS AND METHOD FOR DETECTING MULTI-FEED OF RECORDING MEDIUM AND APPARATUS AND METHOD FOR FORMING IMAGE

(75) Inventors: Minoru OHSHIMA, Ebina-shi (JP); Kaoru YOSHIDA, Ashigarakami-gun (JP); Yoshinari IWAKI, Ebina-shi (JP); Takao FURUYA, Ebina-shi (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/269,709

(22) Filed: Nov. 12, 2008

(30) Foreign Application Priority Data
Apr. 2, 2008 (JP) 2008-095963

(51) Int. Cl. G06F 15/00; G01B 21/02

(52) U.S. Cl. 702/170

(57) ABSTRACT

A recording medium thickness measuring apparatus includes: an output value detection unit that detects an output value which fluctuates in accordance with thickness of a recording medium passing through a predetermined position of a transport path; and a calculation unit that calculates the thickness of the recording medium based on a first output value detected by the output value detection unit before passage of the recording medium and after passage of an immediately preceding recording medium in the predetermined position of the transport path, and a second output value detected by the output value detection unit while the recording medium is passing through the predetermined position.

### CROSS-REFERENCE TO RELATED APPLICATIONS

This application is based on and claims priority under 35 USC 119 from Japanese Patent Application No. 2008-095963 filed Apr. 2, 2008.

### BACKGROUND

### Technical Field

The present invention relates to an apparatus and a method for measuring a transported recording medium thickness, an apparatus and a method for detecting multi-feed of a recording medium and an apparatus and a method for forming an image.

### SUMMARY

A first recording medium thickness measuring apparatus according to an aspect of the present invention includes: an output value detection unit that detects an output value which fluctuates in accordance with thickness of a recording medium passing through a predetermined position of a transport path; and a calculation unit that calculates the thickness of the recording medium based on a first output value detected by the output value detection unit before passage of the recording medium and after passage of an immediately preceding recording medium in the predetermined position of the transport path, and a second output value detected by the output value detection unit while the recording medium is passing through the predetermined position.

### BRIEF DESCRIPTION OF THE DRAWINGS

Exemplary embodiments of the present invention will be described in detail based on the following figures, wherein:

FIG. 1 is a cross-sectional view showing an image forming apparatus 10 according to a first exemplary embodiment of the present invention;

FIG. 2 is a perspective view of a particular structure of the image forming apparatus 10 according to the first exemplary embodiment of the present invention, mainly showing a fluctuation value detection sensor 64 and transport rollers 38;

FIG. 3A is a cross-sectional view schematically showing the structure of the fluctuation value detection sensor 64 of the image forming apparatus 10 according to the first exemplary embodiment of the present invention;

FIG. 3B is a top view showing the structure of the fluctuation value detection sensor 64 of the image forming apparatus 10 according to the first exemplary embodiment of the present invention;

FIG. 4A is a timing chart showing output values from the paper detection sensor 66 and the fluctuation value detection sensor 64;

FIG. 4B illustrates data contents stored in a memory 100 of a controller 60 and multi-feed determination processing by the controller 60, in the image forming apparatus 10 according to the first exemplary embodiment of the present invention;

FIG. 5 is a flowchart showing paper thickness data calculation processing (S10) in the image forming apparatus 10 according to the first exemplary embodiment of the present invention;

FIG. 6 is a flowchart showing multi-feed detection processing (S20) in the image forming apparatus 10 according to the first exemplary embodiment of the present invention;

FIG. 7 illustrates data contents stored in the memory 100 of the controller 60 and multi-feed determination processing by the controller 60, in the image forming apparatus 10 according to a second exemplary embodiment of the present invention;

FIG. 8 is a flowchart showing the paper thickness data calculation processing (S30) in the image forming apparatus 10 according to the second exemplary embodiment of the present invention;

FIG. 9 is a flowchart showing the paper thickness data calculation processing (S40) in the image forming apparatus 10 according to a third exemplary embodiment of the present invention;

FIG. 10 is a flowchart showing the paper thickness data calculation processing (S50) in the image forming apparatus 10 according to a fourth exemplary embodiment of the present invention;

FIG. 11 is a flowchart showing the paper thickness data calculation processing (S60) in the image forming apparatus 10 according to a fifth exemplary embodiment of the present invention;

FIG. 12 illustrates data contents stored in the memory 100 of the controller 60 and multi-feed determination processing by the controller 60, in the image forming apparatus 10 according to a sixth exemplary embodiment of the present invention;

FIG. 13A is a cross-sectional view schematically showing the structure of a fluctuation value detection sensor 88 of the image forming apparatus 10 according to a seventh exemplary embodiment of the present invention;

FIG. 13B is a top view showing the structure of the fluctuation value detection sensor 88 of the image forming apparatus 10 according to the seventh exemplary embodiment of the present invention;

FIG. 14 is a cross-sectional view showing the image forming apparatus 10 according to an eighth exemplary embodiment of the present invention;

FIG. 15 is a perspective view of a particular structure of the image forming apparatus 10 according to the eighth exemplary embodiment of the present invention mainly showing a fluctuation value detection sensor 92 and the transport rollers 38; and

FIG. 16 is a cross-sectional view schematically showing the structure of the fluctuation value detection sensor 92 of the image forming apparatus 10 according to the eighth exemplary embodiment of the present invention.

### DETAILED DESCRIPTION

First, an image forming apparatus 10 according to a first exemplary embodiment of the present invention will be described.

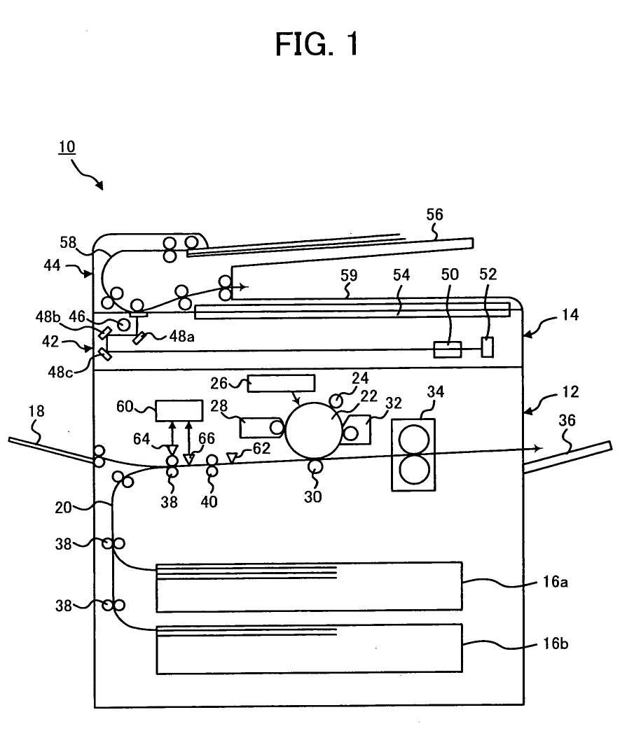

FIG. 1 shows an image forming apparatus 10 according to the first exemplary embodiment of the present invention.

As shown in FIG. 1, the image forming apparatus 10 has an image forming part 12 of e.g. electrophotographic type, a document reading device 14, two stages of paper feed trays 16a and 16b each holding paper, a manual paper feed tray 18 and a controller 60. The image forming apparatus 10 is a multi-function device having e.g. a printing function, a copying function and scanning function. The image forming apparatus 10 forms an image, drawn based on image data read by the document reading device 14 or print data transmitted from an external terminal device (not shown), on paper supplied from the paper feed tray 16a, the paper feed tray 16b or the manual paper feed tray 18 to the paper transport path 20.

Note that the image forming apparatus 10 may be a printer or a facsimile machine. Further, the image forming part 12 may be a device of a different type from the electrophotographic type (e.g., an inkjet type device). The paper is an example of a recording medium, and may be an OHP sheet, a normal paper sheet, a cardboard, glossy paper or the like.

The controller 60 has a CPU, a memory, a storage device such as a hard disk drive, and a communication interface for data transmission/reception with an external computer. The controller 60 controls each of constituent elements included in the image forming apparatus 10 and performs data input/output with each of constituent elements.

The image forming part 12 has an image holder 22, a charger 24 to uniformly charge the image holder 22, an exposure device 26 of e.g. laser scanning type to form a latent image on the image holder 22 uniformly charged by the charger 24, a developing unit 28 to visualize the latent image on the image holder 22 formed by the exposure device 26 with developer, a transfer device 30 to transfer the developer image formed by the developing unit 28 to paper, and a cleaner 32 to clean the developer remained on the image holder 22. Accordingly, the image holder 22 is uniformly charged by the charger 24, then a latent image is formed on the image holder 22 by the exposure device 26, then the latent image is visualized with developer by the developing unit 28, then the developer image is transferred to paper by the transfer device 30, and fixed to the paper by a fixing device 34, and the paper is discharged to a discharge tray 36.

The document reading device 14 has an optical system 42 to optically read an original image and an automatic document feeding device 44 such as an ADF (Auto Document Feeder). The optical system 42 has a lamp 46 to emit light on an original, reflecting mirrors 48a, 48b and 48c to reflect light from the original, a lens 50 to converge the light from the reflecting mirrors 48a to 48c and a read sensor 52 to read the light converged by the lens 50. The read sensor 52 has e.g. CCDs (Charge Coupled Devices). The optical system 42 has a function of skimming through an original fed by the automatic document feeding device 44 to be described later, and a function of scanning the reflecting mirrors 48a to 48c and the like to read an original placed on the platen glass 54.

The automatic document feeding device 44 has an original table 56 on which a large number of originals are placed, an original transport path 58 and a discharge table 59 on which an original from which an image has been read is discharged. Note that the automatic document feeding device 44 is openable/closable, and a lower surface of the automatic document feeding device 44 functions as a platen cover to press an original against the platen glass 54.

The paper transport path 20 is provided with plural transport rollers 38. As one of the transport rollers 38, a registration roller 40 is provided in the vicinity of the upstream side of the transfer device 30. The registration roller 40 is controlled so as to temporarily stop supplied paper based on timing at which an end of the paper has been detected by a registration sensor 62, and in synchronization with timing of formation of a latent image on the image holder 22, supply the paper to the transfer device 30.

Further, the paper transport path 20 is provided with a fluctuation value detection sensor 64 (output value detection unit) on the upstream side of the registration roller 40. The fluctuation value detection sensor 64 detects a value which fluctuates in accordance with thickness of paper conveyed on the paper transport path 20, and outputs the detected value, as an output value, to the controller 60. Further, the paper transport path 20 is provided with a paper detection sensor 66 between the fluctuation value detection sensor 64 and the registration roller 40. The paper detection sensor 66 is e.g. a transmission type photo sensor or a reflection type photo sensor. The paper detection sensor 66 outputs a signal indicating that paper has passed near the paper detection sensor 66 to the controller 60. For example, the paper detection sensor 66 outputs an ON signal at paper passing time, but outputs an OFF signal at paper non-passing time. Accordingly, the controller 60 determines paper passing time and paper non-passing time based on an output signal from the paper detection sensor 66, and in each of paper passing time and paper non-passing time, inputs an output value from the fluctuation value detection sensor 64.

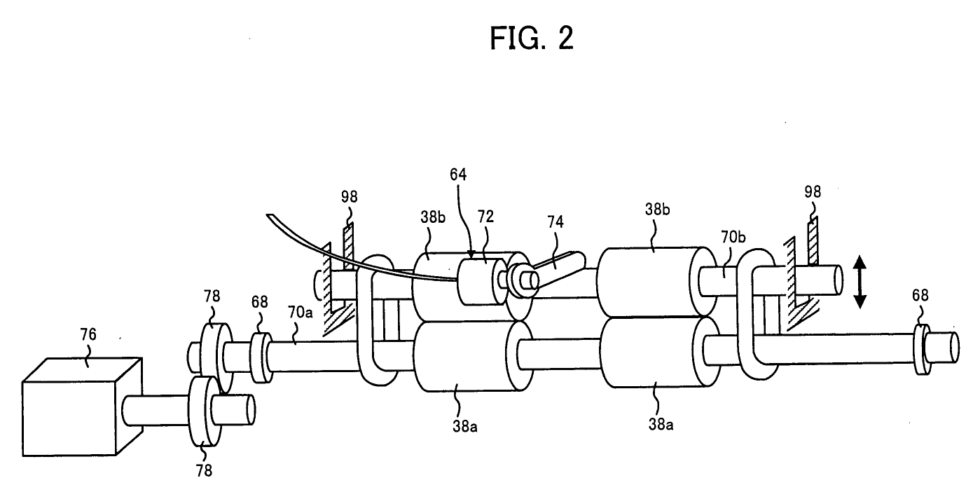

FIG. 2 is a perspective view of a particular structure of the apparatus mainly showing the fluctuation value detection sensor 64 and the transport rollers 38.

As shown in FIG. 2, the image forming apparatus 10 further has a drive motor 76, a roller shaft 70a driven by the drive motor 76 via a gear 78, a bearing 68 provided on the roller shaft 70a and fixed to a main body of the image forming apparatus 10, a transport roller 38a as a drive roller driven by the drive motor 76, a transport roller 38b as a driven roller provided oppositely to the transport roller 38a and rotated in accordance with rotation of the transport roller 38a, a roller shaft 70b as a rotation shaft of the transport roller 38b, and a rocking regulation member 98 to support the roller shaft 70b.

As indicated with an arrow in the figure, the roller shaft 70b and the transport roller 38b are moved in a paper thickness direction in accordance with the rocking regulation member 98 by a nip of paper between the transport roller 38a and the transport roller 38b.

The fluctuation value detection sensor 64 has a displacement sensor 72 and a sensor actuator 74. The sensor actuator 74 is rocked in accordance with the movement of the roller shaft 70b and the transport roller 38b. The displacement sensor 72 detects an output value which fluctuates in accordance with a moving amount of the sensor actuator 74 (that is, a moving amount of the transport roller 38b in the paper thickness direction), and outputs the detected value to the controller 60.

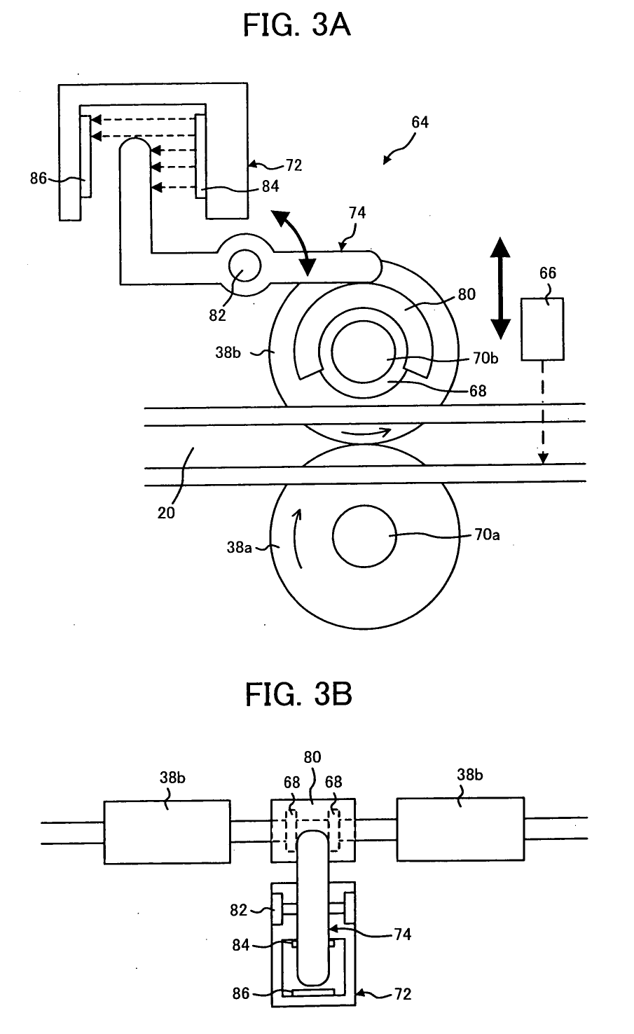

FIG. 3A is a cross-sectional view schematically showing the structure of the fluctuation value detection sensor 64. FIG. 3B is a top view showing the structure of the fluctuation value detection sensor 64.

As shown in FIGS. 3A and 3B, the roller shaft 70b is provided with the bearing 68, and the bearing 68 is covered with a holder 80. The sensor actuator 74 is provided in contact with the holder 80. Accordingly, when the holder 80 is moved in upward/downward directions together with the roller shaft 70b and the bearing 68, in accordance with the movement, the sensor actuator 74 moves about the actuator rotation shaft 82.

The displacement sensor 72 has a light emitting device 84 such as an LED and a photoreception device 86 provided oppositely to the light emitting device 84. The photoreception device 86 receives light emitted from the light emitting device 84, and outputs a received light amount (photoreception amount). That is, the displacement sensor 72 outputs the photoreception amount as its output value to the controller 60.

A part of the sensor actuator 74 is positioned between the light emitting device 84 and the photoreception device 86. Accordingly, some of the light emitted from the light emitting device 84 is blocked with the sensor actuator 74. In this manner, the photoreception amount in the photoreception device 86 fluctuates in accordance with the position of the sensor actuator 74.

In the present exemplary embodiment, when paper is conveyed on the paper transport path 20 and passed between the transport roller 38a and the transport roller 38b, the transport roller 38b is moved upward in correspondence with the thickness of the paper. The sensor actuator 74 is moved in a direction where the photoreception amount in the photoreception device 86 is increased (a direction where a blocking amount is reduced) in accordance with the movement of the transport roller 38b. Accordingly, the fluctuation value detection sensor 64 outputs a predetermined value at paper non-passing time, while it outputs a value greater than the predetermined value at paper passing time. Further, as paper is thicker, the fluctuation value detection sensor 64 outputs a greater value.

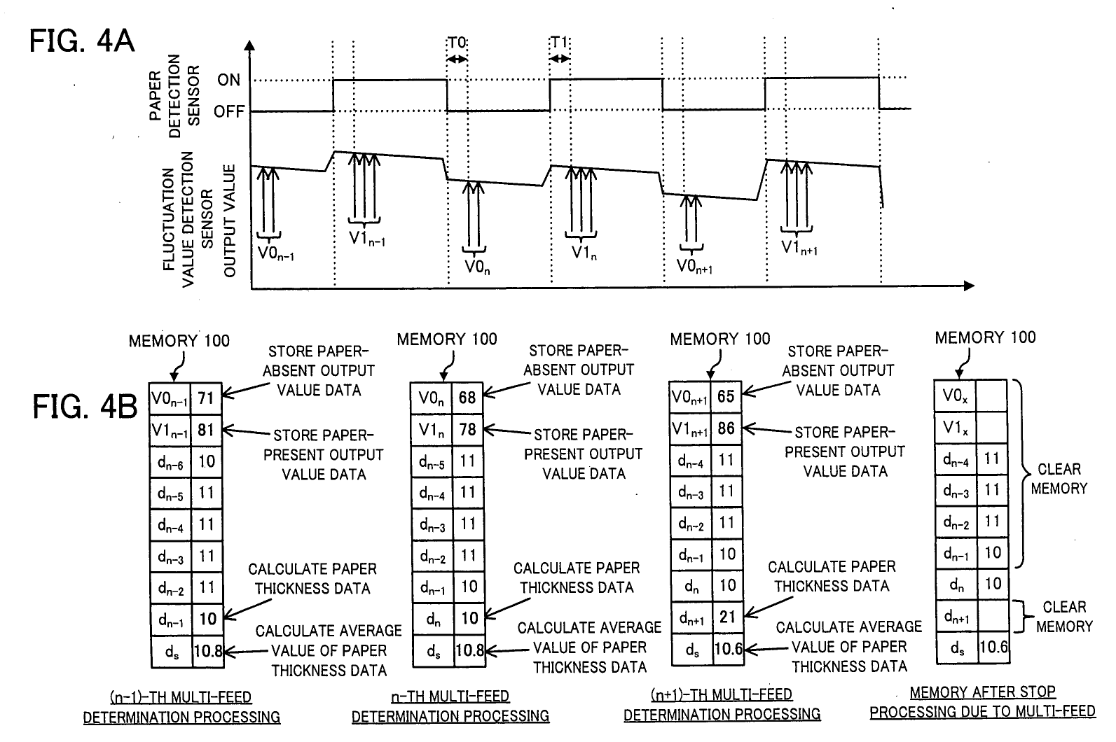

FIGS. 4A and 4B show data contents stored in the memory 100 of the controller 60 and multi-feed determination processing by the controller 60 in the image forming apparatus 10 according to the present exemplary embodiment.

FIG. 4A is a timing chart showing output values from the paper detection sensor 66 and the fluctuation value detection sensor 64. As shown in FIG. 4A, the paper detection sensor 66 outputs an ON signal when paper is passed through a paper detection position of the paper transport path 20 (paper passing time), while it outputs an OFF signal when paper is not passed through the paper detection position (paper non-passing time).

The fluctuation value detection sensor 64 outputs an output value which fluctuates in correspondence with paper thickness to the controller 60. The controller 60 stores the output value from the fluctuation value detection sensor 64, in correspondence with the change of the output value from the paper detection sensor 66 and time elapsed from this change, into the memory 100.

More particularly, the controller 60 stores an output value from the fluctuation value detection sensor 64 after time T0 from the passage of paper through the paper detection position of the paper transport path 20, i.e., after the time T0 from the change of the output value from the paper detection sensor 66 from ON signal to OFF signal, into the memory 100. The stored data is referred to as a paper-absent output value V0 (first output value). In this manner, the paper-absent output value V0 is detected before passage of paper through the paper detection position and after passage of an immediately preceding paper, in a status where the current paper is not in the paper detection position. The controller 60 obtains plural paper-absent output values V0 from the fluctuation value detection sensor 64, calculates an average value of the output values and stores the average value into the memory 100. For example, the paper-absent output value V0n upon n-th determination is an average value of plural output values.

Further, the controller 60 stores an output value from the fluctuation value detection sensor 64 after time T1 from passage of paper through the paper detection position of the paper transport path 20, i.e., after time T1 from change of the output value from the paper detection sensor 66 from OFF signal to ON signal, into the memory 100. The stored data is referred to as a paper-present output value V1 (second output value). The controller 60 obtains plural paper-present output values V1 from the fluctuation value detection sensor 64, calculates an average value of the output values, and stores the average value into the memory 100.

FIG. 4B illustrates data contents stored in the memory 100 and multi-feed determination processing. As shown in FIG. 4B, the memory 100 holds a paper-present output value V1, a paper-absent output value V0 immediately before detection of the paper-present output value V1, plural (e.g., for 6 times) pieces of paper thickness data d, and an average value ds of the plural pieces of paper thickness data.

In the multi-feed determination processing, first, the controller 60 obtains the paper-absent output value V0 and stores the value into the memory 100. Next, the controller 60 obtains the paper-present output value V1 and stores the value into the memory 100. The controller 60 calculates the paper thickness data d from a difference between the paper-present output value V1 and the paper-absent output value V0. Further, the controller 60 calculates the average value ds of paper thickness data for past 5 determinations, and determines occurrence/nonoccurrence of paper multi-feed based on the average value ds of the calculated paper thickness data d and the past paper thickness data. More particularly, with the result of multiplication of the average value ds of the past paper thickness data by a predetermined value α as a threshold value, when the paper thickness data d is less than the threshold value, the controller 60 determines that paper multi-feed has not occurred, while when the paper thickness data d is greater than the threshold value, the controller 60 determines that paper multi-feed has occurred.

For example, in the (n−1)-th multi-feed determination processing, a paper-absent output value V0n−1 is “71”, and a paper-present output value V1n−1 is “81”. In this case, as paper thickness data dn−1, 81−71=10 holds. Further, an average value ds of past paper thickness data (dn−6 to dn−2 (5 times)) is “10.8”. Assuming that α=1.5 holds, 10.8×1.5=16.2 holds as the threshold value. As the paper thickness data dn−1 (10) is less than the threshold value (16.2), the controller 60 determines multi-feed has not occurred.

Further, for example, in the n-th multi-feed determination processing, a paper-absent output value V0n is “68”, and a paper-present output value V1n is “78”. In this case, paper thickness data dn is “10”. Further, an average value ds of past paper thickness data (dn−5 to dn−1 (5 times)) is “10.8”. Accordingly, as in the case of the (n−1)-th determination processing, the threshold value is “16.2”. As the paper thickness data dn (10) is less than the threshold value (10.8), the controller 60 determines that multi-feed has not occurred.

Further, for example, in the (n+1)-th multi-feed determination processing, a paper-absent output value V0n+1 is “65”, and a paper-present output value V1n+1 is “86”. In this case, paper thickness data dn+1 is “21”. Further, an average value ds of past paper thickness data (dn−4 to dn (5 times)) is “10.6”. As the threshold value, 10.6×1.5=15.9 holds. As the paper thickness data dn+1 (21) is greater than the threshold value (10.6), the controller 60 determines that multi-feed has occurred.

Upon determination of occurrence of multi-feed, unlike determination of nonoccurrence of multi-feed, the controller 60 performs exception processing corresponding to the occurrence of multi-feed. The exception processing includes clearance of the contents (or some of the contents) in the memory 100 or the like. When multi-feed has occurred, the controller 60 clears the paper-absent output value V0, the paper-present output value V1, and the paper thickness data d calculated from the output values V1 and V0, and stops the print job.

Further, the controller 60 may determine preceding paper multi-feed. As the determination of preceding paper multi-feed, occurrence/nonoccurrence of preceding multi-feed is determined in the n-th determination processing. For example, with the result of multiplication of the calculated paper thickness data d by the predetermined value α as a threshold value, when the average value ds of past paper thickness data is less than the threshold value, the controller 60 determines that preceding paper multi-feed has not occurred, while when the average value ds of past paper thickness data is greater than the threshold value, the controller 60 determines that preceding paper multi-feed has occurred. Upon determination of occurrence of preceding paper multi-feed, the controller 60 performs exception processing corresponding to the occurrence of preceding paper multi-feed.

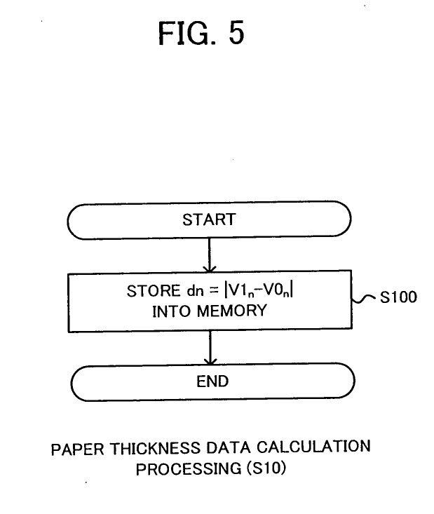

FIG. 5 is a flowchart showing paper thickness data calculation processing (S10) in the image forming apparatus 10 according to the present exemplary embodiment.

As shown in FIG. 5, at step S100, the controller 60 of the image forming apparatus 10 calculates an absolute value of the difference between the paper-present output value V1 and immediately preceding paper-absent output value V0, obtained at the above-described timing, and stores the calculated value as paper thickness data dn into the memory 100.

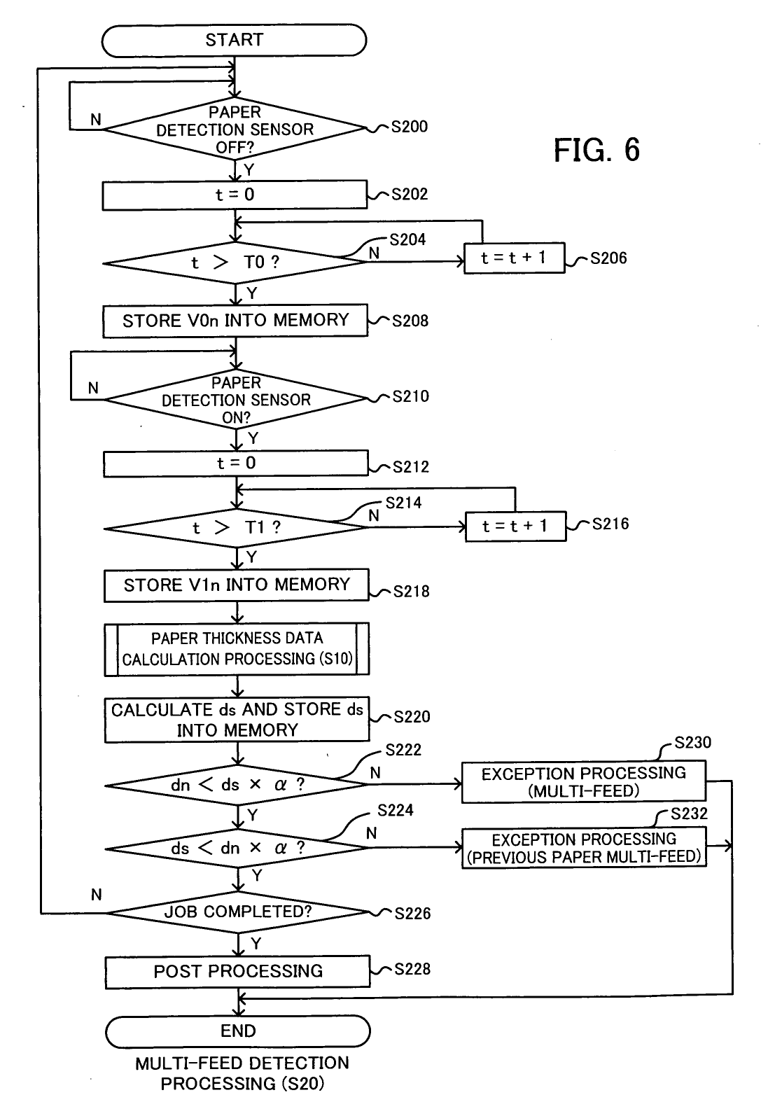

FIG. 6 is a flowchart showing multi-feed detection processing (S20) in the image forming apparatus 10 according to the present exemplary embodiment. Note that in FIG. 6, the n-th multi-feed detection processing will be described. Further, in the subsequent flowcharts, the n-th processing will be described.

As shown in FIG. 6, the controller 60 of the image forming apparatus 10 determines whether or not an output value from the paper detection sensor 66 is an OFF signal. When the output value is an OFF signal, the image forming apparatus 10 proceeds to perform processing at step S202, otherwise, returns to processing at step S200. Note that when the output value from the paper detection sensor 66 is not an OFF signal immediately after the start of print job (e.g., n=1 holds), the controller 60 detects a remaining error indicating that paper upon immediately preceding processing remains, and performs processing corresponding to the remaining error.

At step S202, the controller 60 initializes a time counter t (t=0).

At step S204, the controller 60 determines whether or not the value of the time counter t has exceeded predetermined time T0. When it is determined that the value t has exceeded T0, the image forming apparatus 10 proceeds to processing at step S208, otherwise, proceeds to processing at step S206.

At step S206, the controller 60 increments the time counter value t by one, and returns to the processing at step S204.

At step S208, the controller 60 obtains an output value from the fluctuation value detection sensor 64, and stores the value as a paper-absent output value V0n into the memory 100. Note that the paper-absent output value V0n is an average value of obtained plural output values.

At step S210, the controller 60 determines whether or not the output value from the paper detection sensor 66 is an ON signal. When it is determined that the output value is an ON signal, the image forming apparatus 10 proceeds to processing at step S212, otherwise, returns to the processing at step S210.

At step S212, the controller 60 initializes the time counter t (t=0).

At step S214, the controller 60 determines whether or not the time counter value t has exceeded predetermined time T1. When it is determined that the value t has exceeded the time T1, the image forming apparatus 10 proceeds to processing at step S218, otherwise, proceeds to processing at step S216.

At step S216, the controller 60 increments the time counter value t by one, and returns to the processing at step S214.

At step S218, the controller 60 obtains an output value from the fluctuation value detection sensor 64, and stores the value as a paper-present output value V1n into the memory 100. Note that the paper-present output value V1n is an average value of obtained plural output values.

When the paper-absent output value V0n and the paper-present output value V1n have been obtained, the controller 60 performs the paper thickness data calculation processing S10 (FIG. 5). After completion of the paper thickness data calculation processing S10, at step S220, the controller 60 calculates an average value ds of past paper thickness data, and stores the value into the memory 100.

At step S222, the controller 60 compares the paper thickness data dn with a threshold value calculated from the average value ds of past paper thickness data and the predetermined value α, and determines whether or not the paper thickness data dn is less than the threshold value. When it is determined that the paper thickness data dn is less than the threshold value, the image forming apparatus 10 proceeds to processing at step S224, otherwise, proceeds to processing at step S230.

At step S224, the controller 60 compares the average value ds of past paper thickness data with the threshold value calculated from the paper thickness data dn and the predetermined value α, and determines whether or not the average value ds of paper thickness data is less than the threshold value. When it is determined that the average value ds of paper thickness data is less than the threshold value, the image forming apparatus 10 proceeds to processing at step S226, otherwise, proceeds to processing at step S232.

At step S226, the controller 60 determines whether or not the print job has been completed. When it is determined that the print job has been completed, the image forming apparatus 10 proceeds to processing at step S228, otherwise, returns to the processing at step S200.

At step S228, the controller 60 clears the paper-absent output value V0n and the paper-present output value V1n stored in the memory 100, and terminates the multi-feed determination processing.

At step S230, the controller 60 performs exception processing corresponding to occurrence of multi-feed. More particularly, the controller 60 displays a message indicating the occurrence of multi-feed on a display (not shown) such as a touch panel or a liquid crystal display, or sends an electronic mail including the message to a predetermined user as an administrator or the like, thereby notifies the occurrence of multi-feed. Further, the controller 60 stops the print job, and clears the paper-absent output value V0n, the paper-present output value V1n and the paper thickness data dn calculated from the values V0n and V01 stored in the memory 100.

At step S232, the controller 60 performs exception processing corresponding to occurrence of preceding paper multi-feed. As in the case of the occurrence of multi-feed, the controller 60 notifies the occurrence of preceding paper multi-feed, stops the print job, and clears the predetermined data stored in the memory 100.

As described above, the image forming apparatus 10 according to the present exemplary embodiment measures a paper thickness based on an output value at paper passing time and an immediately preceding output value at paper non-passing time. Accordingly, even when an ambient environment such as a temperature has changed before acquisition of output values, the image forming apparatus 10 can measure a paper thickness without influence of the change. Further, the image forming apparatus 10 can determine occurrence/nonoccurrence of multi-feed based on the paper thickness measured without influence of change of ambient environment.

Next, the image forming apparatus 10 according to second to fifth exemplary embodiments of the present invention will be described.

The image forming apparatus 10 according to the second to fifth exemplary embodiments of the present invention is different from the image forming apparatus 10 according to the first exemplary embodiment in that the image forming apparatus 10 according to the second to fifth exemplary embodiments determines whether or not an output value from the fluctuation value detection sensor 64 is influenced by a factor different from paper thickness such as change of ambient environment before calculation of paper thickness data. Note that hereinbelow, the influence by a factor different from paper thickness is also represented as influence by output fluctuation.

The image forming apparatus 10 according to the second exemplary embodiment of the present invention stores a past paper-absent output value V0 into the memory 100, and determines based on an average value of the past paper-absent output values V0 and a paper-absent output value V0 immediately before paper passage whether or not an output value from the fluctuation value detection sensor 64 is influenced by an output fluctuation.

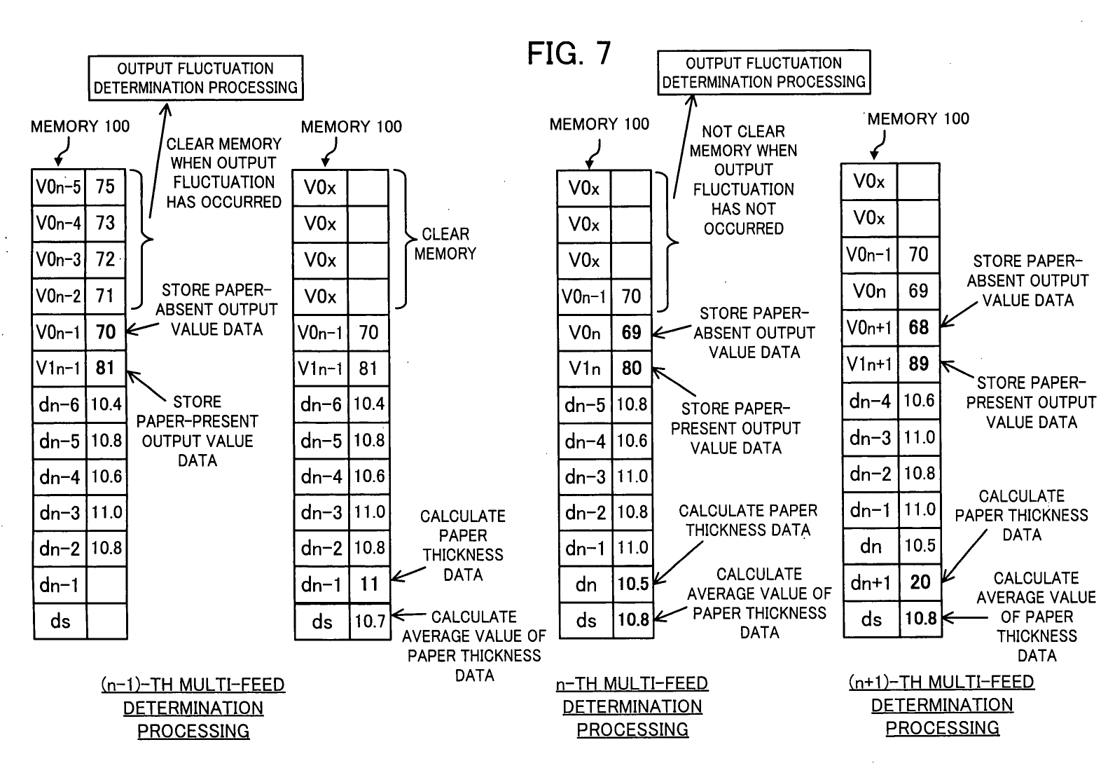

FIG. 7 illustrates data contents stored in the memory 100 of the controller 60 and the multi-feed determination processing by the controller 60, in the image forming apparatus 10 according to the present exemplary embodiment.

As shown in FIG. 7, the memory 100 holds past plural (e.g. for 4 times) paper-absent output values V0, in addition to the data shown in FIG. 4B.

In the multi-feed determination processing, the controller 60 obtains a paper-absent output value V0 and a paper-present output value V1 and stores the values into the memory 100, and performs processing for determination of occurrence/nonoccurrence of output fluctuation. More particularly, the controller 60 calculates an average value of the past plural paper-absent output values V0 stored in the memory 100, calculates a difference between the average value and a currently obtained paper-absent output value V0, and determines whether or not the calculated value is less than a predetermined threshold value β. When the calculated value is less than the threshold value β, the controller 60 determines that the output value from the fluctuation value detection sensor 64 is not influenced by an output fluctuation, otherwise, determines that the fluctuation value detection sensor 64 is influenced by an output fluctuation.

The controller 60 calculates paper thickness data d from a difference between the paper-present output value V1 and the average value of the paper-absent output values V0 stored in the memory 100. More particularly, when it is determined that the output value is not influenced by an output fluctuation, the controller 60 calculates an average value of the plural paper-absent output values V0 already stored in the memory 100 and the paper-absent output value V0 currently stored in the memory 100. Further, when it is determined that the output value is influenced by an output fluctuation, the controller 60 clears the plural paper-absent output values already stored in the memory 100, and uses the paper-absent output value V0 currently stored in the memory 100.

For example, in the (n−1)-th multi-feed determination processing shown in FIG. 7, the paper-absent output value V0n−1 is “70”, and the paper-present output value V1n−1 is “81”. Further, the paper-absent output values V0n−5 to V0n−2 are “75”, “73”, “71” and “71”. In this case, an average value of the already-stored output values V0n−5 to V0n−2 is “72.3”. Accordingly, as an absolute value of a difference between the average value and the paper-absent output value V0n−1, 72.3−70=2.3 holds. Assuming that the threshold value β=2.0 holds, as 2.3>threshold value β (2.0) holds, the controller 60 determines that the output value from the fluctuation value detection sensor 64 is influenced by an output fluctuation.

In this case, the controller 60 clears the values V0n−5 to V0n−2 stored in the memory 100. As the paper thickness data dn−1, 81−70=11 holds. Further, the average value ds of past paper thickness data (dn−6 to dn−2 (S times)) is “10.7”. Assuming that α=1.5 holds, 10.7×1.5=16.1 holds as the threshold value. Accordingly, as the paper thickness data dn−1 (11) is less than the threshold value (16.1), the controller 60 determines that multi-feed has not occurred.

Further, for example, in the n-th multi-feed determination processing, the paper-absent output value V0n is “69”, and the paper-present output value V1n is “80”. As an average value of already stored output values V0 (only V0n−1 in this example) is “70”, 70−69=1 holds an absolute value of a difference between the average value and the paper-absent output value V0n. Since the absolute value is less than the threshold value β, the controller 60 determines that the output value from the fluctuation value detection sensor 64 is not influenced by an output fluctuation.

In this case, the controller 60 calculates that the paper thickness data d is “10.5” from a difference between the paper-present output value V1n (80) and the average value of the paper-absent output values V0 (70 and 69) stored in the memory 100. Further, an average value of past paper thickness data is obtained as “10.8”. Assuming that α=1.5 holds, 10.8×1.5=16.2 holds as the threshold value. Accordingly, as the paper thickness data dn (10.5) is less than the threshold value (16.2), the controller 60 determines that multi-feed has not occurred.

Further, for example, in the (n+1)-th multi-feed determination processing, the paper-absent output value V0n+1 is “68”, and the paper-present output value V1n+1 is “89”. In this case, as an average value of the already stored output values V0 (V0n−1 and V0n in this example) is “69.5”, 69.5−68=1.5 holds as an absolute value of a difference between the average value and the paper-absent output value V0n+1. Since the absolute value is less than the threshold value β, the controller 60 determines that the output value from the fluctuation value detection sensor 64 is not influenced by an output fluctuation.

In this case, the controller 60 calculates that the paper thickness data d as “20” from a difference between the paper-present output value V1n+1 (89) and the average value of the paper-absent output values V0 (70, 69 and 68) stored in the memory 100. Further, an average value of past paper thickness data is obtained as “10.8”. Assuming that α=1.5 holds, 10.8×1.5=16.2 holds as the threshold value. Since the paper thickness data dn (20) is greater than the threshold value (16.2), the controller 60 determines that multi-feed has occurred.

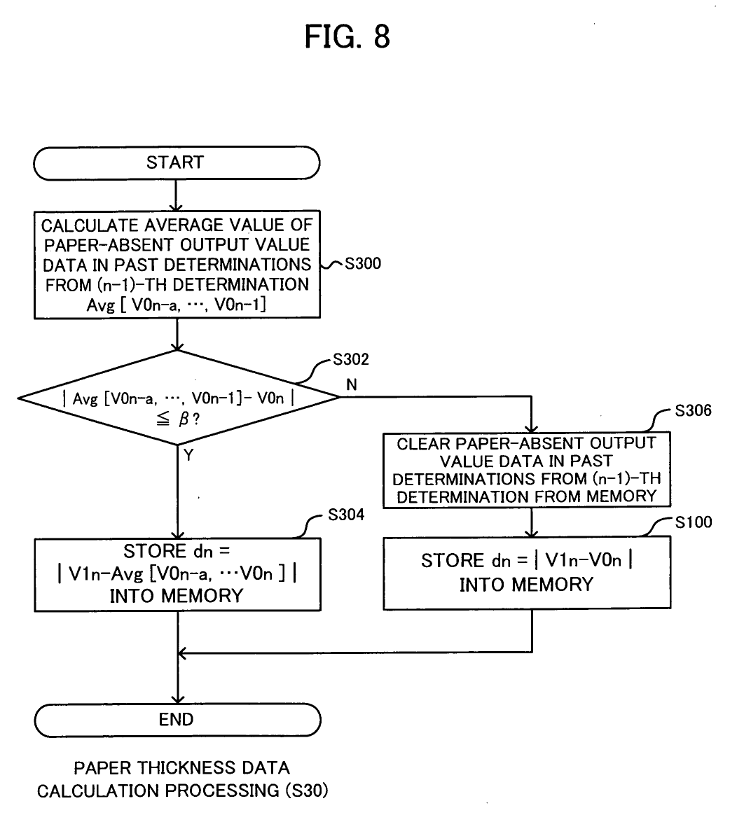

FIG. 8 is a flowchart showing the paper thickness data calculation processing (S30) in the image forming apparatus 10 according to the present exemplary embodiment. Note that among steps shown in FIG. 8, steps substantially the same as those in FIG. 5 have the same reference numerals.

As shown in FIG. 8, at step S300, the controller 60 of the image forming apparatus 10 calculates an average value of paper-absent output values V0n−a to V0n−1 in past determinations from the (n−1)-th determination stored in the memory 100.

At step S302, the controller 60 determines whether or not an absolute value of a difference between the calculated average value and the paper-absent output value V0n is less than the threshold value β. When the average value is less than the threshold value β, the image forming apparatus 10 proceeds to processing at step S304, otherwise, proceeds to processing at step S306.

At step S304, the controller 60 calculates an absolute value of a difference between the obtained paper-present output value V1n and the paper-absent output values V0n-a to V0n stored in the memory 100, and stores the calculated value as the paper thickness data dn into the memory 100.

At step S306, the controller 60 clears the paper-absent output values V0n−a to V0n−1 in the past determinations from the (n−1)-th determination stored in the memory 100. Further, at S100, the controller 60 calculates an absolute value of a difference between the paper-present output value V1 and its immediately preceding paper-absent output value V0, and stores the calculated value as the paper thickness data dn into the memory 100.

As described above, the image forming apparatus 10 according to the present exemplary embodiment determines whether or not the output value from the fluctuation value detection sensor 64 is influenced by an output fluctuation using already-stored past paper non-passing time output values. The image forming apparatus 10 calculates paper thickness data by a method which differs in correspondence with the result of determination. Accordingly, when the output value is influenced by an output fluctuation, the image forming apparatus 10 can measure a paper thickness using only nearest data.

Next, the image forming apparatus 10 according to a third exemplary embodiment of the present invention will be described.

The image forming apparatus 10 according to the third exemplary embodiment of the present invention is different from the image forming apparatus 10 according to the second exemplary embodiment in that the image forming apparatus 10 according to the third exemplary embodiment determines based on time elapsed from energization of the fluctuation value detection sensor 64 whether or not the output value from the fluctuation value detection sensor 64 is influenced by an output fluctuation.

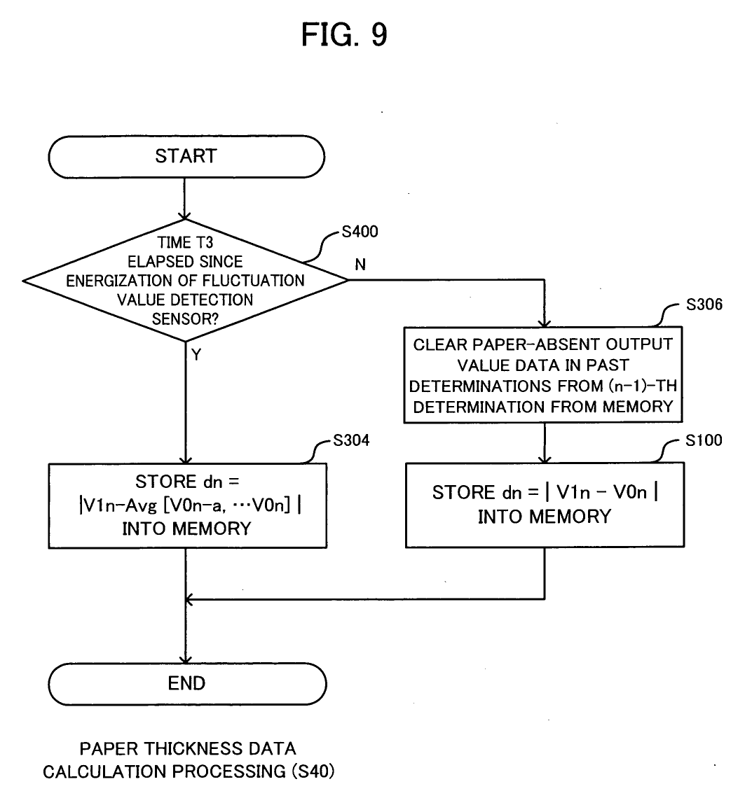

FIG. 9 is a flowchart showing the paper thickness data calculation processing (S40) in the image forming apparatus 10 according to the present exemplary embodiment. Note that among the steps shown in FIG. 9, steps substantially the same as those in FIG. 8 have the same reference numerals.

As shown in FIG. 9, at step S400, the controller 60 of the image forming apparatus 10 determines whether or not predetermined time T3 has elapsed since energization of the fluctuation value detection sensor 64. When it is determined that the predetermined time T3 has elapsed, the image forming apparatus 10 proceeds to processing at step S304, otherwise, proceeds to processing at step S306. Then, as in the case of the image forming apparatus 10 according to the second exemplary embodiment, the paper thickness data dn is calculated and stored into the memory 100.

Note that the determination standard in the image forming apparatus 10 according to the present exemplary embodiment may be provided in the image forming apparatus 10 according to the second exemplary embodiment. More particularly, the determination standard for the processing at step S400 is provided in the image forming apparatus 10 according to the second exemplary embodiment. For example, the processing at step S400 is added, as preprocessing of step S300, in the paper thickness data calculation processing S30 shown in FIG. 8. In this case, the image forming apparatus 10 first performs the processing at step S400, then when it is determined that the predetermined time T3 has elapsed, the image forming apparatus 10 proceeds to the processing at step S300, otherwise, proceeds to processing at step S306.

Accordingly, when it is determined that predetermined time has not elapsed from energization of the fluctuation value detection sensor 64, the image forming apparatus 10 according to the present exemplary embodiment measures a paper thickness using only the nearest data. Even when a change of a temperature as ambient environment is remarkable immediately after power supply, a paper thickness can be measured with reduced variation.

Next, the image forming apparatus 10 according to a fourth exemplary embodiment of the present invention will be described.

The image forming apparatus 10 according to the fourth exemplary embodiment of the present invention is different from the image forming apparatus according to the second and third exemplary embodiments in that the image forming apparatus 10 according to the fourth exemplary embodiment has a temperature sensor (not shown) provided in the vicinity of the fluctuation value detection sensor 64, and determines based on the amount of temperature change detected by the temperature sensor whether or not the output value from the fluctuation value detection sensor 64 is influenced by an output fluctuation.

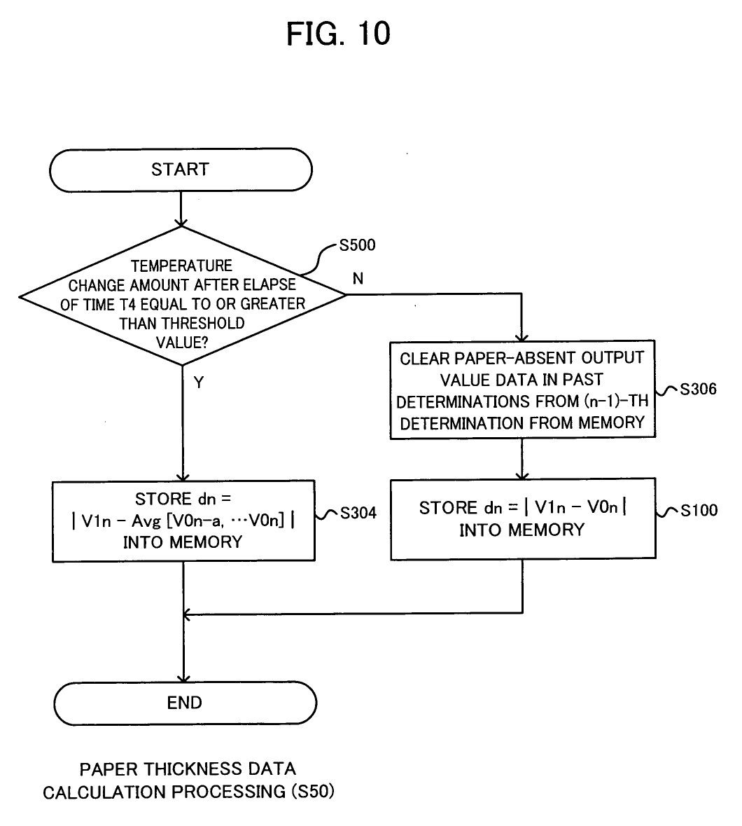

FIG. 10 is a flowchart showing the paper thickness data calculation processing (S50) in the image forming apparatus 10 according to the present exemplary embodiment. Note that among the steps shown in FIG. 10, steps substantially the same as those in FIG. 8 have the same reference numerals.

As shown in FIG. 10, at step S500, the controller 60 of the image forming apparatus 10 receives temperature information from the temperature sensor, and determines whether or not the amount of temperature change after elapse of predetermined time T4 from base time (e.g., preceding determination) is equal to or greater than a predetermined threshold value. When the amount of temperature change is equal to or greater than the threshold value, the image forming apparatus 10 proceeds to the processing at step S304, otherwise, proceeds to the processing at step S306. Then, as in the case of the image forming apparatus 10 according to the second exemplary embodiment, the paper thickness data dn is calculated and stored into the memory 100.

Note that the determination standard in the image forming apparatus 10 according to the present exemplary embodiment may be provided in the image forming apparatus 10 according to the second and third exemplary embodiments. More particularly, the determination standard for the processing at step S500 is provided in the image forming apparatus 10 according to the second exemplary embodiment. For example, the processing at step S500 is performed by every elapse of time T4.

In this manner, as the image forming apparatus 10 according to the present exemplary embodiment has a temperature sensor, it can use a temperature in the vicinity of the fluctuation value detection sensor 64 in determination of influence of output fluctuation. Accordingly, the image forming apparatus 10 according to the present exemplary embodiment can reduce the influence by temperature change in the vicinity of the fluctuation value detection sensor 64.

Next, the image forming apparatus 10 according to a fifth exemplary embodiment of the present invention will be described.

The image forming apparatus 10 according to the fifth exemplary embodiment of the present invention is different from the image forming apparatus 10 according to the first to fourth exemplary embodiments in that paper thickness data is calculated using a value detected by the fluctuation value detection sensor 64 within past predetermined time.

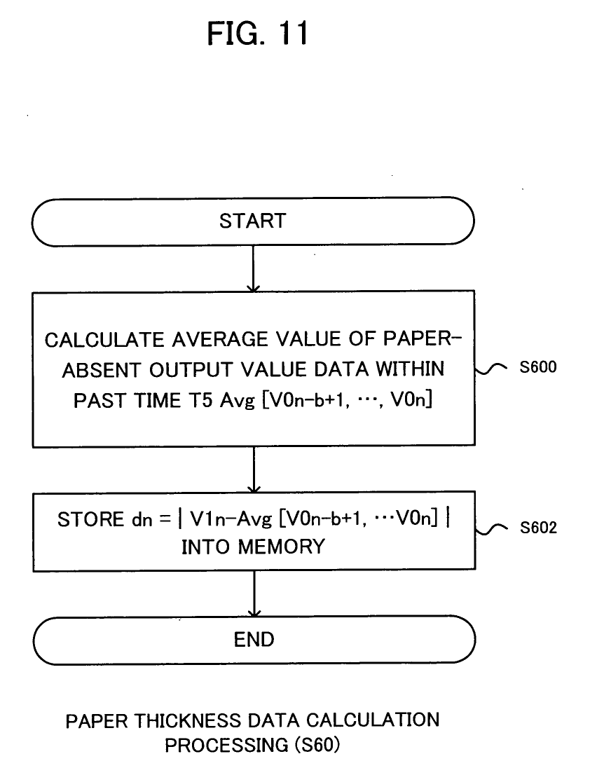

FIG. 11 is a flowchart showing the paper thickness data calculation processing (S60) in the image forming apparatus 10 according to the present exemplary embodiment.

As shown in FIG. 11, at step S600, the controller 60 of the image forming apparatus 10 calculates an average value of paper-absent output values V0n−b+1 to V0n obtained within past time T5 from acquisition of the paper-absent output value V0n (or acquisition of paper-present output value V1n) upon the n-th determination.

At step S602, the controller 60 calculates an absolute value of a difference between the obtained paper-present output value V1n and the calculated average value, and stores the calculated value as the paper thickness data dn into the memory 100.

In this manner, the image forming apparatus 10 according to the present exemplary embodiment calculates paper thickness data using the paper-absent output value V0 obtained within limited time. Even when ambient environment such as a temperature changes before acquisition of these paper-absent output values V0, a paper thickness can be measured without influence of the change.

Next, the image forming apparatus 10 according to a sixth exemplary embodiment of the present invention will be described.

The image forming apparatus 10 according to the sixth exemplary embodiment of the present invention is different from the image forming apparatus 10 according to the first to fifth exemplary embodiments in that the paper-absent output value V0 is not stored but only the paper-present output value V1 is stored and used in calculation of paper thickness data.

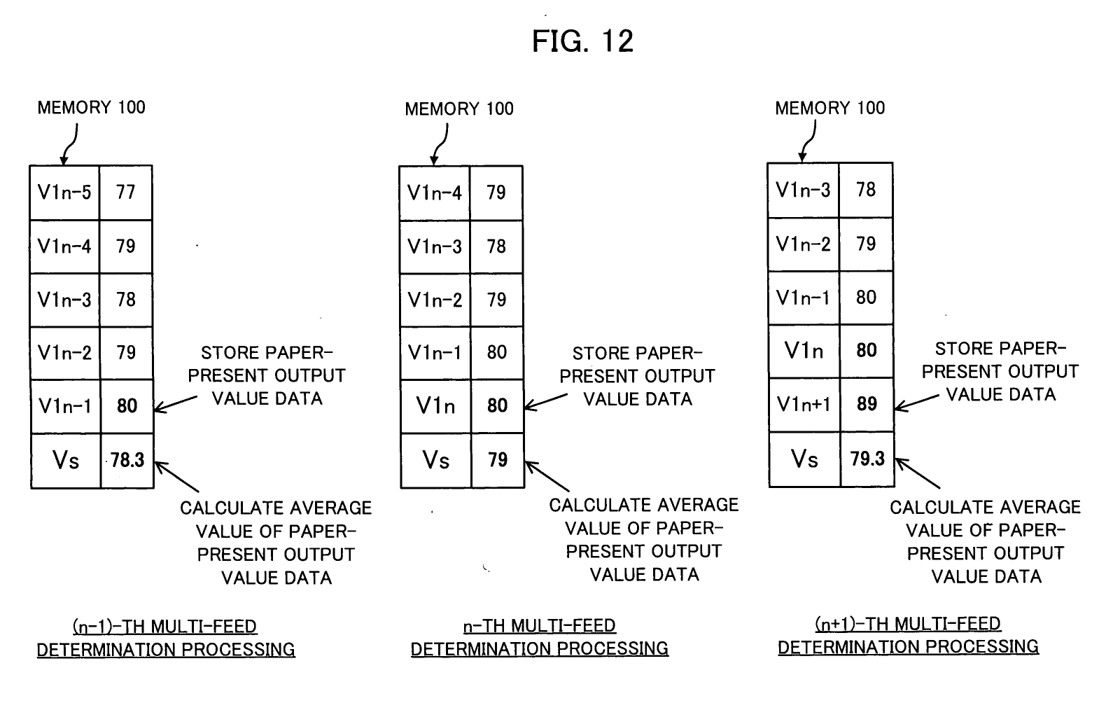

FIG. 12 illustrates data contents stored in the memory 100 of the controller 60 and multi-feed determination processing by the controller 60 in the image forming apparatus 10 according to the present exemplary embodiment of the present invention.

As shown in FIG. 12, the memory 100 holds the paper-present output value V1, past plural (e.g., 4 times) paper-present values V1 and an average value of the past plural paper-present output values V1.

In the multi-feed determination processing, the controller 60 obtains the paper-present output value V1 and stores the value into the memory 100, and performs determination of occurrence/nonoccurrence of output fluctuation. More particularly, the controller 60 calculates an average value of past plural (4 times in this example) paper-present output values V1 stored in the memory 100. Then the controller 60 calculates an absolute value of a difference between the average value and a currently-obtained paper-present output value V1, and determines whether or not the calculated value is less than a predetermined threshold value. When the calculated value is less than the threshold value, the controller 60 determines that the output value from the fluctuation value detection sensor is not influenced by an output fluctuation, otherwise, determines that the output value from the fluctuation detection sensor is influenced by an output fluctuation.

The controller 60 calculates the paper thickness data d from a difference between the paper-present output value V1 and predetermined paper-absent output value V0. More particularly, when it is determined that the output value is not influenced by an output fluctuation, the controller 60 calculates an average value of plural paper-present output values V1 already stored in the memory 100 and the paper-present output value V1 currently stored in the memory 100, and calculates a difference between the calculated value and the predetermined paper-absent output value V0. Further, when it is determined that the output value is influenced by an output fluctuation, the controller 60 clears the plural paper-present output values already stored in the memory 100, and calculates a difference between the paper-present output value V1 currently stored in the memory 100 and the predetermined paper-absent output value V0.

Accordingly, when the output value is influenced by an output fluctuation, the image forming apparatus 10 according to the present exemplary embodiment can measure a paper thickness by using only the nearest data.

The determination standard in the image forming apparatus 10 according to the present exemplary embodiment may be provided in the image forming apparatus 10 according to the first exemplary embodiment. In this case, the controller 60 of the image forming apparatus 10 obtains both the paper-absent output value V0 and the paper-present output value V1, and calculates the paper thickness data d using the obtained paper-absent output value V0 in place of the predetermined paper-absent output value V0.

Next, the image forming apparatus 10 according to a seventh exemplary embodiment of the present invention will be described.

In the image forming apparatus 10 according to the seventh exemplary embodiment of the present invention, having the configuration of the image forming apparatus 10 according to the first to sixth exemplary embodiments, the fluctuation value detection sensor 64 is replaced with a fluctuation value detection sensor 88.

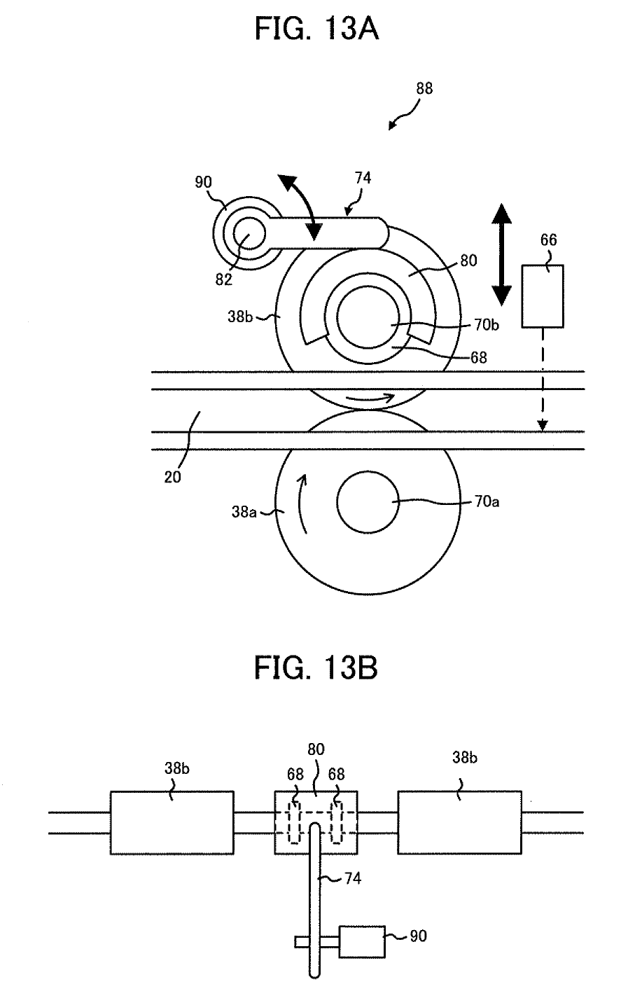

FIG. 13A is a cross-sectional view schematically showing the structure of the fluctuation value detection sensor 88. FIG. 13B is a top plan view showing the structure of the fluctuation value detection sensor 88.

As shown in FIGS. 13A and 13B, the fluctuation value detection sensor 88 has the sensor actuator 74 in contact with the holder 80, an actuator rotation shaft 82 and a displacement sensor 90. The displacement sensor 90 detects a moving amount of the sensor actuator 74 (the amount of rotation about the actuator rotation shaft 82), and outputs the detected value to the controller 60.

For example, in the structure shown in FIGS. 13A and 13B, the sensor actuator 74 is moved in a counterclockwise direction in accordance with upward movement of the transport roller 38b. Assuming that the direction is a normal direction, the fluctuation value detection sensor 88 outputs a predetermined value at paper non-passing time, while outputs a value greater than the predetermined time at paper passing time. Further, the fluctuation value detection sensor 88 outputs a greater value as a paper thickness is greater.

Next, the image forming apparatus 10 according to an eighth exemplary embodiment of the present invention will be described.

In the image forming apparatus 10 according to the eighth exemplary embodiment of the present invention, having the configuration of the image forming apparatus 10 according to the first to sixth exemplary embodiments, the fluctuation value detection sensor 64 is replaced with a fluctuation value detection sensor 92.

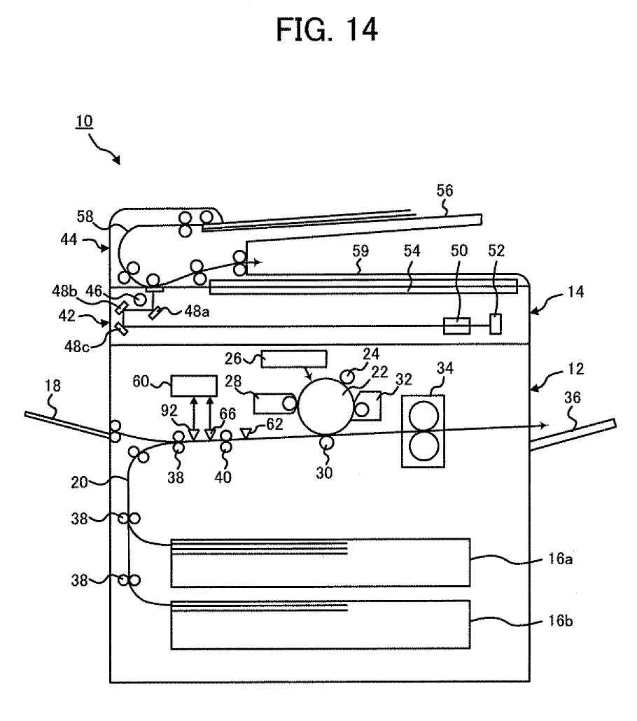

FIG. 14 is a cross-sectional view showing the image forming apparatus 10 according to the eighth exemplary embodiment of the present invention. Note that among the constituent elements shown in FIG. 14, elements substantially the same as those shown in FIG. 1 have the same reference numerals.

As shown in FIG. 14, in the image forming apparatus 10 according to the present exemplary embodiment, the paper transport path 20 is provided with the fluctuation value detection sensor 92 in place of the fluctuation value detection sensor 64. The fluctuation value detection sensor 92 is provided so as to be in contact with paper conveyed on the paper transport path 20. The fluctuation value detection sensor 92 detects a value which fluctuates in accordance with thickness of paper in contact with the sensor, and outputs the detected value, as an output value, to the controller 60.

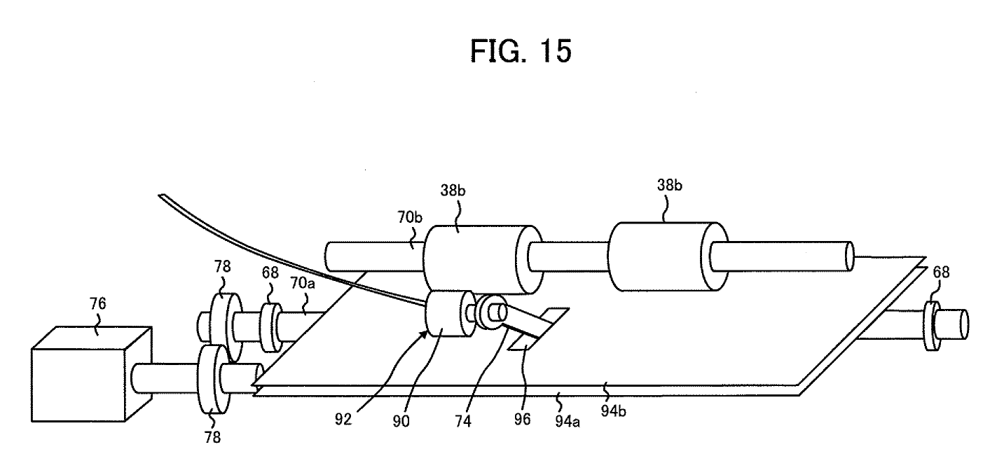

FIG. 15 is a perspective view of a particular structure of the apparatus mainly showing the fluctuation value detection sensor 92 and the transport rollers 38. Note that among the constituent elements shown in FIG. 15, elements substantially the same as those shown in FIG. 2 have the same reference numerals.

As shown in FIG. 15, the fluctuation value detection sensor 92 has the sensor actuator 74 and the displacement sensor 90. An end of the sensor actuator 74 on the opposite side to the rotation shaft is provided to be positioned on the transport path 20 via an opening 96 provided on a frame 94b forming an upper surface of the paper transport path 20.

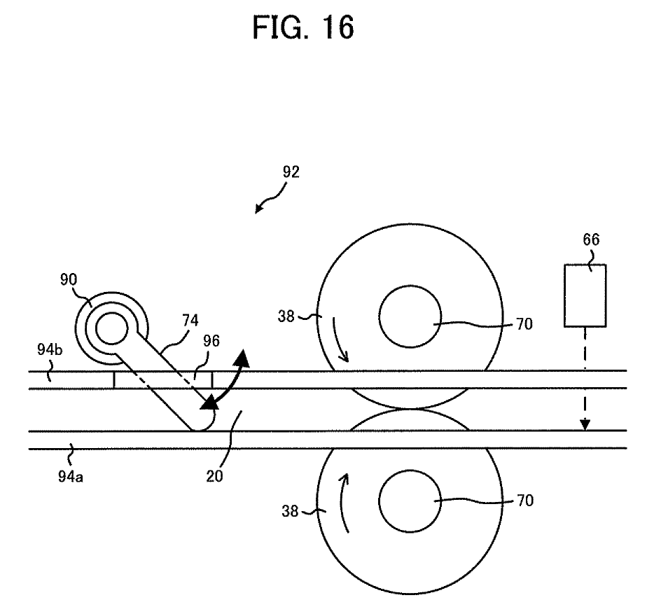

FIG. 16 is a cross-sectional view schematically showing the structure of the fluctuation value detection sensor 92.

As shown in FIG. 16, the fluctuation value detection sensor 92 is provided such that the end of the sensor actuator 74 on the opposite side to the rotation shaft is in contact with a frame 94a forming a lower surface of the paper transport path 20. The displacement sensor 90 detects a moving amount of the sensor actuator 74, and outputs the detected value to the controller 60.

For example, in the structure shown in FIG. 16, the sensor actuator 74 is in contact with conveyed paper and is moved in the counterclockwise direction in correspondence with thickness of the paper. Assuming that the direction is a normal direction, the fluctuation value detection sensor 92 outputs a predetermined value at paper non-passing time, while outputs a value greater than the predetermined time at paper passing time. Further, the fluctuation value detection sensor 92 outputs a greater value as a paper thickness is greater.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording medium thickness measuring apparatus comprising:
an output value detection unit that detects an output value which fluctuates in accordance with thickness of a recording medium passing through a predetermined position of a transport path; and
a calculation unit that calculates the thickness of the recording medium based on a first output value detected by the output value detection unit before passage of the recording medium and after passage of an immediately preceding recording medium in the predetermined position of the transport path, and a second output value detected by the output value detection unit while the recording medium is passing through the predetermined position.

2. The recording medium thickness measuring apparatus according to claim 1, further comprising an output value storage unit that stores the first output value detected by the output value detection unit,
wherein the calculation unit determines whether or not the output value detected by the output value detection unit is influenced by a factor different from the thickness of the recording medium, and
when the output value is not influenced by the factor different from the thickness of the recording medium, the calculation unit calculates the thickness of the recording medium further based on the first output value stored in the output value storage unit.

3. The recording medium thickness measuring apparatus according to claim 2, wherein the calculation unit performs determination based on time from energization of the output value detection unit.

4. The recording medium thickness measuring apparatus according to claim 2, wherein the calculation unit performs determination based on a value calculated from the first output value stored in the output value storage unit and the first output value detected by the output value detection unit before passage of the recording medium and after passage of the immediately preceding recording medium in the predetermined position of the transport path.

5. The recording medium thickness measuring apparatus according to claim 2, further comprising a temperature detection unit that detects a temperature,
wherein the calculation unit performs determination based on the temperature detected by the temperature detection unit.

6. The recording medium thickness measuring apparatus according to claim 1, further comprising an output value storage unit that stores the first output value detected by the output value detection unit,
wherein the calculation unit calculates the thickness of the recording medium further based on the first output value stored in the output value storage unit and detected within past predetermined time.

7. The recording medium thickness measuring apparatus according to claim 1, wherein the output value detection unit has a rocking member, and detects a moving amount of the rocking member moving in contact with the recording medium passing through the predetermined position of the transport path.

8. The recording medium thickness measuring apparatus according to claim 1, further comprising a transport unit including a drive roller, and a driven roller provided movably in a thickness direction of the recording medium and rotated in accordance with the drive roller,
wherein the output value detection unit detects a moving amount of the driven roller of the transport unit.

9. A recording medium thickness measuring apparatus comprising:
an output value detection unit that detects an output value which fluctuates in accordance with thickness of a recording medium passing through a predetermined position of a transport path;
an output value storage unit that stores the output value detected by the output value detection unit while the recording medium is passing through the predetermined position of the transport path; and
a calculation unit that calculates the thickness of the recording medium based on the output value stored in the output value storage unit and the output value detected by the output value detection unit while the recording medium is passing through the predetermined position of the transport path.

10. A recording medium thickness measuring apparatus comprising:
an output value detection unit that detects an output value which fluctuates in accordance with thickness of a recording medium passing through a predetermined position of a transport path;
a second output value storage unit that stores a second output value detected by the output value detection unit while the recording medium is passing through the predetermined position of the transport path; and
a calculation unit that determines whether or not the output value detected by the output value detection unit is influenced by a factor different from the thickness of the recording medium, and when the output value is not influenced by the factor different from the thickness of the recording medium, calculates the thickness of the recording medium based on a first output value detected by the output value detection unit before passage of the recording medium and after passage of an immediately preceding recording medium in the predetermined position of the transport path and the second output value detected by the output value detection unit while the recording medium is passing through the predetermined position, while when the output value is influenced by the factor different from the thickness of the recording medium, calculates the thickness of the recording medium based on the second output value stored in the second output value storage unit and the second output value detected by the output value detection unit while the recording medium is passing through the predetermined position of the transport path.

11. A recording medium multi-feed detection apparatus comprising:
an output value detection unit that detects an output value which fluctuates in accordance with thickness of a recording medium passing through a predetermined position of a transport path; and
a multi-feed determination unit that determines occurrence/nonoccurrence of multi-feed by calculating the thickness of the recording medium based on a first output value detected by the output value detection unit before passage of the recording medium and after passage of an immediately preceding recording medium in the predetermined position of the transport path, and a second output value detected by the output value detection unit while the recording medium is passing through the predetermined position.

12. An image forming apparatus comprising:
an output value detection unit that detects an output value which fluctuates in accordance with thickness of a recording medium passing through a predetermined position of a transport path; and
a multi-feed determination unit that determines occurrence/nonoccurrence of multi-feed by calculating the thickness of the recording medium based on a first output value detected by the output value detection unit before passage of the recording medium and after passage of an immediately preceding recording medium in the predetermined position of the transport path, and a second output value detected by the output value detection unit while the recording medium is passing through the predetermined position,
when the multi-feed determination unit determines that multi-feed has occurred, processing different from processing upon determination of nonoccurrence of multi-feed being performed.

13. A method for measuring recording medium thickness comprising:
detecting an output value which fluctuates in accordance with thickness of a recording medium passing through a predetermined position of a transport path; and
calculating the thickness of the recording medium based on a first output value detected before passage of the recording medium and after passage of an immediately preceding recording medium in the predetermined position of the transport path, and a second output value detected while the recording medium is passing through the predetermined position.

14. A method for measuring recording medium thickness comprising:
detecting an output value which fluctuates in accordance with thickness of a recording medium passing through a predetermined position of a transport path;
storing the output value detected while the recording medium is passing through the predetermined position of the transport path; and
calculating the thickness of the recording medium based on the stored output value and the output value detected while the recording medium is passing through the predetermined position of the transport path.

15. A method for measuring recording medium thickness comprising:
detecting an output value which fluctuates in accordance with thickness of a recording medium passing through a predetermined position of a transport path;
storing a second output value detected while the recording medium is passing through the predetermined position of the transport path; and
determining whether or not the detected output value is influenced by a factor different from the thickness of the recording medium, and when the output value is not influenced by the factor different from the thickness of the recording medium, calculates the thickness of the recording medium based on a first output value detected before passage of the recording medium and after passage of an immediately preceding recording medium in the predetermined position of the transport path and the second output value detected while the recording medium is passing through the predetermined position, while when the output value is influenced by the factor different from the thickness of the recording medium, calculates the thickness of the recording medium based on the stored second output value and the second output value detected while the recording medium is passing through the predetermined position of the transport path.

16. A method for detecting multi-feed of recording medium comprising:
detecting an output value which fluctuates in accordance with thickness of a recording medium passing through a predetermined position of a transport path; and
determining occurrence/nonoccurrence of multi-feed by calculating the thickness of the recording medium based on a first output value detected before passage of the recording medium and after passage of an immediately preceding recording medium in the predetermined position of the transport path, and a second output value detected while the recording medium is passing through the predetermined position.

17. A method for forming image comprising:
detecting an output value which fluctuates in accordance with thickness of a recording medium passing through a predetermined position of a transport path; and
determining occurrence/nonoccurrence of multi-feed by calculating the thickness of the recording medium based on a first output value detected before passage of the recording medium and after passage of an immediately preceding recording medium in the predetermined position of the transport path, and a second output value detected while the recording medium is passing through the predetermined position,
when it is determined that multi-feed has occurred, processing different from processing upon determination of nonoccurrence of multi-feed being performed.
